(19) United States
(12) Patent Application Publication
(10) Pub. No.: US 2016/0109766 A1
(43) Pub. Date: Apr. 21, 2016

(54) LIQUID CRYSTAL DISPLAY HAVING IMPROVED RESPONSE SPEED AND SIDE VISIBILITY

(71) Applicant: SAMSUNG DISPLAY CO., LTD., Yongin-si (KR)

(72) Inventors: Ho Kil OH, Yongin-si (KR); Ka Eun KIM, Yongin-si (KR); Cheol SHIN, Hwaseong-si (KR); Se Hyun LEE, Seoul (KR); Hak Sun CHANG, Yongin-si (KR); Ki Chul SHIN, Seongnam-si (KR)

(21) Appl. No.: 14/919,483

(22) Filed: Oct. 21, 2015

(30) Foreign Application Priority Data
Oct. 21, 2014 (KR) 10-2014-0142525

(51) Int. Cl. G02F 1/1343

(52) U.S. Cl. CPC G02F 1/134309; G02F 2001/134345

(57) ABSTRACT

A liquid crystal display, including: a first substrate; a pixel electrode formed on the first substrate and including a first subpixel electrode and a second subpixel electrode which are separated from each other; a second substrate facing the first substrate; a common electrode formed on the second substrate; and a liquid crystal layer positioned between the first substrate and the second substrate, wherein the first subpixel electrode includes a first part having a plurality of first branch electrodes, the second subpixel electrode includes a second part which is positioned to at least partially surround the first branch electrodes, and a plurality of second branch electrodes which extend from the second part and are defined by a plurality of first opens. Portions of the first opens proximate to the second part are wider than other portions of the first opens.

### CROSS-REFERENCE TO RELATED APPLICATION

This application claims priority to, and the benefit of, Korean Patent Application No. 10-2014-0142525 filed in the Korean Intellectual Property Office on Oct. 21, 2014, the entire contents of which are incorporated herein by reference.

### BACKGROUND

(a) Field

Embodiments of the present invention relate generally to liquid crystal displays. More specifically, embodiments of the present invention relate to liquid crystal displays having improved response speed and side visibility.

(b) Description of the Related Art

A liquid crystal display is one of the most common types of flat panel displays. It typically includes two sheets of display panels in which field generating electrodes, such as a pixel electrode and a common electrode, are formed and a liquid crystal layer is interposed therebetween. In the liquid crystal display, the field generating electrode has a voltage applied thereto, in order to generate an electric field in the liquid crystal layer. This electric field determines the orientation of liquid crystal molecules of the liquid crystal layer, and polarization of incident light is controlled based on the generated electric field, so as to display an image.

A vertically aligned mode liquid crystal display has liquid molecules that are aligned so that major axes thereof are oriented vertically, or perpendicular to a display panel, in the state in which no electric field is applied. In the vertically aligned mode liquid crystal display, it is often desirable to secure a wide viewing angle. For this purpose, a method for forming a plurality of domains by forming openings such as fine slits in a field generating electrode, and the like is used.

When multiple branch electrodes are made by forming fine slits in a pixel electrode, the liquid crystal molecules may be controlled even in central regions of each domain, but an aperture ratio of the liquid crystal display may be reduced.

Meanwhile, in the case of the vertically aligned mode liquid crystal display, to make side visibility approximate front visibility, a method for making transmittance different by dividing one pixel into two subpixels and applying different voltages to the two subpixels has been suggested. However, when one pixel is divided into the two subpixels, behaviors of the liquid crystal molecules are irregular at a boundary portion between the two subpixels, and thus the transmittance deteriorates at the boundary portion between the two subpixels.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a liquid crystal display in which the response speed of liquid crystal molecules is improved without reducing an aperture ratio of the liquid crystal display, while also having side visibility similar to front visibility. This is at least partially accomplished by widening widths of ends of opens of a plurality of branch electrodes.

An exemplary embodiment of the present invention provides a liquid crystal display including: a first substrate; a pixel electrode formed on the first substrate and including a first subpixel electrode and a second subpixel electrode which are separated from each other; a second substrate facing the first substrate; a common electrode formed on the second substrate; and a liquid crystal layer positioned between the first substrate and the second substrate. The first subpixel electrode includes a first part having a plurality of first branch electrodes, and the second subpixel electrode includes a second part which is positioned to at least partially surround the first branch electrodes, and a plurality of second branch electrodes which extend from the second part and are defined by a plurality of first opens. Portions of the first opens proximate to the second part are wider than other portions of the first opens.

A difference between a first voltage configured to be applied to the first subpixel electrode and a common voltage configured to be applied to the common electrode may be larger than a difference between a second voltage configured to be applied to the second subpixel electrode and the common voltage.

The first part of the first subpixel electrode may have a substantially quadrilateral shape, and the second part of the second subpixel electrode may have a plurality of substantially trapezoidal shapes.

The plurality of first branch electrodes may extend from the first part and be separated from each other by a plurality of second opens. Portions of the second opens proximate to the first part may be wider than other portions of the second opens.

The first part of the first subpixel electrode may have a substantially quadrilateral shape, the second part of the second subpixel electrode may have a plurality of substantially trapezoidal shapes, the plurality of first branch electrodes may include a first fine branch part, a second fine branch part, a third fine branch part, and a fourth fine branch part which extend in different directions, and the plurality of second branch electrodes may include a fifth fine branch part, a sixth fine branch part, a seventh fine branch part, and an eighth fine branch part which extend in different directions.

Adjacent ones of the first opens may have differing lengths, and longer ones of the first opens may have ends that are wider than ends of shorter ones of the first opens.

Adjacent ones of the second opens may have differing lengths, and longer ones of the second opens may have ends that are wider than ends of shorter ones of the second opens.

According to an exemplary embodiment of the present invention, it is possible to improve the response speed of a liquid crystal display without reducing the aperture ratio of the liquid crystal display, while also making the side visibility similar to the front visibility. This may be accomplished by forming extending parts where the widths of the ends of the opens between the plurality of branch electrodes are widened.

### BRIEF DESCRIPTION OF THE DRAWINGS

FIG. 1 is a layout view of a liquid crystal display according to an exemplary embodiment of the present invention.

FIG. 2 is a cross-sectional view of the liquid crystal display of FIG. 1 taken along the line II-II.

FIG. 3A and FIG. 3B are plan views illustrating a basic region of a field generating electrode of the liquid crystal display according to the exemplary embodiment of the present invention.

FIG. 4 is a conceptual diagram illustrating an alignment direction of directors of liquid crystal molecules of the liquid crystal display according to the exemplary embodiment of the present invention.

FIG. 5 is a cross-sectional view illustrating the alignment direction of the directors of the liquid crystal molecules of the liquid crystal display according to the exemplary embodiment of the present invention.

FIG. 6 is a plan view illustrating a basic region of a field generating electrode of a liquid crystal display according to another exemplary embodiment of the present invention.

FIG. 7 is a cross-sectional view illustrating the alignment direction of the directors of the liquid crystal molecules of the liquid crystal display according to another exemplary embodiment of the present invention.

FIG. 8 is a plan view illustrating a basic region of a field generating electrode of the liquid crystal display according to another exemplary embodiment of the present invention.

FIG. 9 is a diagram illustrating measured transmittances of the liquid crystal display according to the exemplary embodiment of the present invention.

The various Figures are not necessarily to scale.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

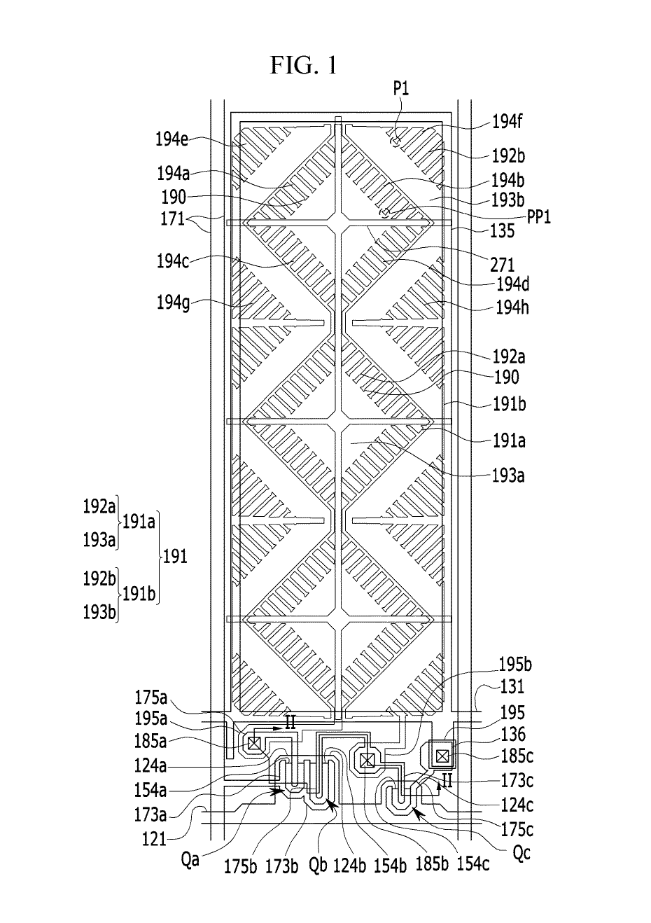

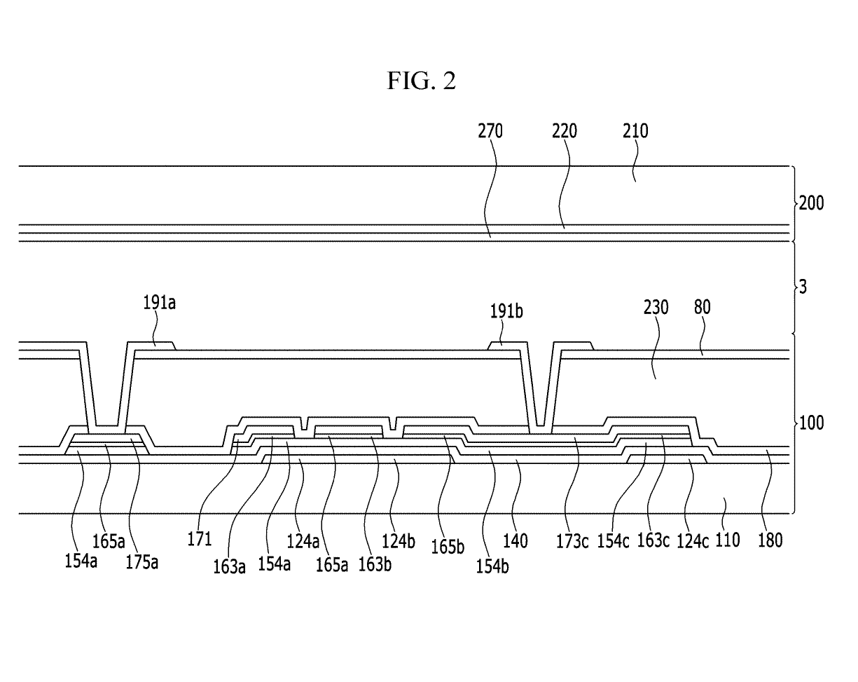

Hereinafter, a liquid crystal display according to an exemplary embodiment of the present invention will be described with reference to FIGS. 1 and 2. FIG. 1 is a layout view of a liquid crystal display according to an exemplary embodiment of the present invention and FIG. 2 is a cross-sectional view of the liquid crystal display of FIG. 1 taken along the line II-II.

Referring to FIGS. 1 and 2, the liquid crystal display according to the exemplary embodiment of the present invention includes a first display panel 100 and a second display panel 200 which face each other, a liquid crystal layer 3 interposed between the two display panels 100 and 200, and a pair of polarizers (not illustrated) attached to outer sides of the display panels 100 and 200.

First, the first display panel 100 will be described.

A gate line 121, a reference voltage line 131, and a storage electrode 135 are formed on a first substrate 110. The gate line 121 mainly extends in a horizontal direction to transfer a gate signal.

The gate line 121 includes a wide end (not illustrated) so as to allow other components to be connected to a first gate electrode 124a, a second gate electrode 124b, a third gate electrode 124c, and other layers or external driving circuits.

The reference voltage line 131 may extend substantially parallel with the gate line 121 and may have an extending part 136 which is connected to a third drain electrode 175c to be described below.

The reference voltage line 131 includes the storage electrode 135 which encloses a pixel area.

A gate insulating layer 140 is formed on the gate line 121, the reference voltage line 131, and the storage electrode 135.

A first semiconductor 154a, a second semiconductor 154b, and a third semiconductor 154c, which may each be made of amorphous or crystalline silicon, etc., are formed on the gate insulating layer 140. Here, semiconductors 154a, b, c are different parts of the same layer.

A plurality of ohmic contacts 163a, 163b, 163c, 165a, 165b, and 165c are formed on the first semiconductor 154a, the second semiconductor 154b, and the third semiconductor 154c. When the semiconductors 154a, 154b, and 154c are made of an oxide semiconductor, the ohmic contacts may be omitted.

Data conductors 171, 173a, 173b, 173c, 175a, 175b, and 175c, which include a data line 171 including a first source electrode 173a and a second source electrode 173b, a first drain electrode 175a, a second drain electrode 175b, a third source electrode 173c, and a third drain electrode 175c, are formed on the ohmic contacts 163a, 163b, 163c, 165a, 165b, and 165c and the gate insulating layer 140.

The second drain electrode 175b is connected to the third source electrode 173c.

The first gate electrode 124a, the first source electrode 173a, and the first drain electrode 175a form a first thin film transistor Qa together with the first semiconductor 154a and a channel of a thin film transistor Qa is formed at the semiconductor part 154a between the first source electrode 173a and the first drain electrode 175a. Similarly, the second gate electrode 124b, the second source electrode 173b, and the second drain electrode 175b form a second thin film transistor Qb together with the second semiconductor 154b, and the channel of the thin film transistor Qb is formed at the semiconductor part 154b between the second source electrode 173b and the second drain electrode 175b. Likewise, the third gate electrode 124c, the third source electrode 173c, and the third drain electrode 175c form a third thin film transistor Qc together with the third semiconductor 154c, and the channel of the thin film transistor Qc is formed at the semiconductor part 154c between the third source electrode 173c and the third drain electrode 175c.

A passivation layer 180, which may be made of inorganic insulating materials such as silicon nitride or silicon oxide, is formed on the data conductors 171, 173a, 173b, 173c, 175a, 175b, and 175c and the exposed semiconductor parts 154a, 154b, and 154c.

A color filter 230 is positioned on the passivation layer 180.

A light blocking member (not illustrated) may be positioned in an area in which the color filter 230 is not positioned and/or on a portion of the color filter 230. The light blocking member can be referred to as black matrix and stops light from being leaked.

A capping layer 80 is positioned on the color filter 230. The capping layer 80 prevents the color filter 230 from being lifted and suppresses pollution of the liquid crystal layer 3 due to organic materials such as a solvent introduced from the color filter, thereby preventing defects such as afterimage which may occur when a screen is driven.

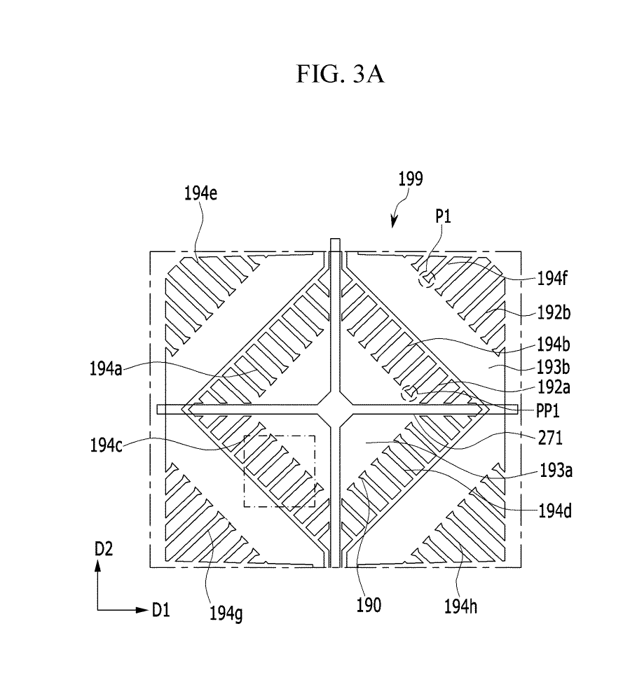

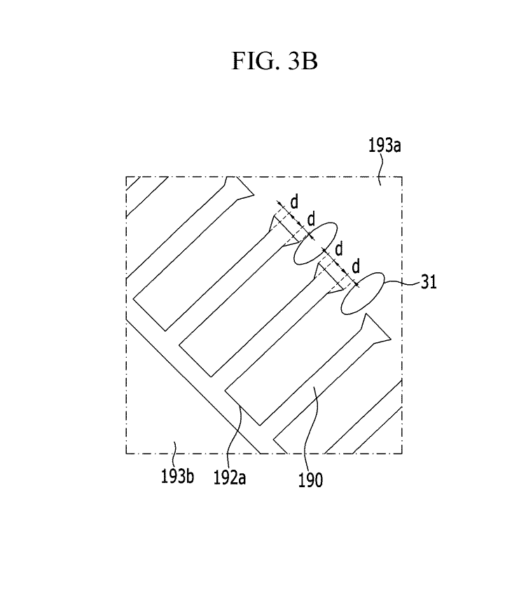

A pixel electrode 191, which includes a first subpixel electrode 191a and a second subpixel electrode 191b, is formed on the capping layer 80. The first subpixel electrode 191a and the second subpixel electrode 191b include one or more electrodes such as a basic electrode 199 illustrated in FIGS. 3A and 3B and/or a differently-shaped electrode.

The first subpixel electrode 191a and the second subpixel electrode 191b are spaced apart from each other at what is shown here as a constant interval.

The second subpixel electrode 191b is formed to enclose the first subpixel electrode 191a in plan view.

Edges of the first subpixel electrode 191a are provided with a plurality of first branch electrodes 192a. The plurality of first branch electrodes 192a extends from a first plate-shaped part 193a which has a rhombus shape. Here, the term “plate shape” means a shape having a continuous regular geometric shape without cutouts or grooves therein, such as a square.

That is, the first subpixel electrode 191a includes a first plate-shaped part 193a which is positioned at a middle portion thereof and a plurality of first branch electrodes 192a which enclose the first plate-shaped part 193a and extend from the first plate-shaped part 193a.

Openings which are formed between adjacent first branch electrodes 192a of the first subpixel electrode 191a according to the exemplary embodiment of the present invention include an extending part 190. The extending part 190 is wide at an end PP1 corresponding to a location at which the first branch electrode 192a meets the first plate-shaped part 193a.

Generally, as the size of the first plate-shaped part 193a is increased, an aperture ratio is increased but the ability to control liquid crystal molecules may be weakened. Conversely, as the amount of space occupied by the first branch electrodes 192a is increased, the aperture ratio is reduced but the ability to control liquid crystal molecules is increased. Therefore, an appropriate ratio of the size of the first plate-shaped part 193a to the size of the first branch electrode 192a portion may have an important effect on the aperture ratio and the ability to control the liquid crystal molecules.

In particular, the liquid crystal molecules which are positioned at the middle portion of the first plate-shaped part 193a are controlled by the liquid crystal molecules which are affected by the fringe field occurring at the boundary portion of the edge of the first plate-shaped portion 193a. According to the exemplary embodiment of the present invention, the extending part 190 is formed at the end PP1 of the gap between the first branch electrodes 192a, effectively lengthening the edges of the first plate-shaped part 193a.

Therefore, the boundary portion of the edge of the first plate-shaped part 193a is made wider by the extending parts 190, so that it exerts greater control over the liquid crystal molecules which are positioned near edges of the first plate-shaped part 193a.

That is, the extending parts 190 are formed at the ends PP1 of the gaps formed between the first branch electrodes 192a of the first subpixel electrode 191a, to further define the boundary portions of the edges of the first plate-shaped part 193a. In this manner, the effect of the fringe field which may be applied to the liquid crystal molecules positioned at the boundary portion of the first plate-shaped part 193a is greater. Liquid crystal molecules near this increased fringe field are affected to a greater degree, and their increased movement also influences those liquid crystal molecules positioned near the middle of the first plate-shaped part 193a. The configuration of this embodiment thus acts to improve control of the liquid crystal molecules which are positioned at the whole of the first plate-shaped part 193a, not just those near edges of the first plate-shaped part 193a, thereby improving the overall response speed of the liquid crystal molecules.

A central portion of the first plate-shaped part 193a of the first subpixel electrode 191a overlaps a central portion of a cruciform opening 271 which is formed in a common electrode 270 to be described below.

The first branch electrodes 192a of the first subpixel electrode 191a extend in different directions. In more detail, the first branch electrodes 192a include a plurality of first fine branch parts 194a which obliquely extend upward left from the first plate-shaped part 193a, a plurality of second fine branch parts 194b which obliquely extend upward right therefrom, a plurality of third fine branch parts 194c which obliquely extend downward left therefrom, and a plurality of fourth fine branch parts 194d which obliquely extend downward right therefrom.

The second subpixel electrode 191b includes a second plate-shaped part 193b which encloses or surrounds the plurality of first branch electrodes 192a of the first subpixel electrode 191a, and a plurality of second branch electrodes 192b which surround and extend from the second plate-shaped part 193b.

The second plate-shaped part 193b of the second subpixel electrode 191b generally has a plan-view shape comprising four trapezoid-shaped structures positioned around the first fine branch parts to the fourth fine branch parts 194a, 194b, 194c, and 194d of the first subpixel electrode 191a. Similar to the first branch electrodes 192a of the first subpixel electrode 191a, the plurality of second branch electrodes 192b of the second subpixel electrode 191b include a plurality of fifth fine branch parts 194e which obliquely extend upward left from the second plate-shaped part 193b, a plurality of sixth fine branch parts 194f which obliquely extend upward right therefrom, a plurality of seventh fine branch parts 194g which obliquely extend downward left therefrom, and a plurality of eighth fine branch parts 194h which obliquely extend downward right therefrom.

The opens or gaps which are formed between the plurality of first branch electrodes 192a of the first subpixel electrode 191a according to the exemplary embodiment of the present invention include the extending part 190 where the width of the open is wider at the end PP1 of the open corresponding to the position at which the first branch electrode 192a begins to extend from the first plate-shaped part 193a.

Generally, as the first plate-shaped part 193a is made wider, the aperture ratio is increased but the degree of control over the liquid crystal molecules may be weakened. Conversely, as the portion occupied by the first branch electrode 192a is made wider, the aperture ratio is reduced but the degree of control over the liquid crystal molecules is increased. Therefore, the ratio of the area of the first plate-shaped part 193a to that of the first branch electrode 192a portion may have a significant effect on the aperture ratio and the control power of the liquid crystal molecules.

In particular, the liquid crystal molecules which are positioned at the middle portion of the first plate-shaped part 193a are partly controlled by the liquid crystal molecules which are affected by the fringe field generated at the boundary portion of the edge of the first plate-shaped part 193a. According to the exemplary embodiment of the present invention, the extending parts 190 are formed at the ends PP1 of the gaps between first branch electrodes 192a, thus further defining and effectively widening the edges of the first plate-shaped part 193a.

Therefore, liquid crystal molecules near the edge of the first plate-shaped part 193a are affected to a greater degree by the fringe field, and thus the degree of control over those liquid crystal molecules which are positioned at the first plate-shaped part 193a may be increased.

Also, as liquid crystal molecules positioned at the boundary portion of the first plate-shaped part 193a influence those liquid crystal molecules positioned at the middle portion of the first plate-shaped part 193a, the degree of control over those liquid crystal molecules which are positioned at the whole of the first plate-shaped part 193a, not just at its boundaries, is thus improved.

The first to fourth fine branch parts 194a, 194b, 194c, and 194d and the fifth to eighth fine branch parts 194e, 194f, 194g, and 194h are each oriented at approximately ±45° or ±135° with respect to the gate line 121. The two fine branch parts 194a, 194b, 194c, 194d, 194e, 194f, 194g, and 194h which extend in different directions and are adjacent to each other may be orthogonal to each other.

A first contact hole 185a which exposes a portion of a first drain electrode 175a and a second contact hole 185b which exposes a portion of a second drain electrode 175b are formed in the passivation layer 180 and the capping layer 80. The extending part 136 of the reference voltage line 131, and a third contact hole 185c which exposes the third drain electrode 175c, are formed in the gate insulating layer 140, the passivation layer 180, and the capping layer 80.

A first extending part 195a of the first subpixel electrode 191a is physically and electrically connected to the first drain electrode 175a through the first contact hole 185a, and the second extending part 195b of the second subpixel electrode 191b is physically and electrically connected to the second drain electrode 175b through the second contact hole 185b.

The first subpixel electrode 191a and the second subpixel electrode 191b each receive a data voltage from the first drain electrode 175a and the second drain electrode 175b through the first contact hole 185a and the second contact hole 185b, respectively.

A connecting member 195 is formed on the extending part 136 of the reference voltage line 131 which is exposed through the third contact hole 185c, and the third drain electrode 175c is physically and electrically connected to the extending part 136 through the connecting member 195.

Hereinafter, the second display panel 200 will be described.

A light blocking member 220 and the common electrode 270 are formed on the second substrate 210.

The common electrode 270 has the plurality of cruciform opens or openings 271. As illustrated in FIGS. 3A and 3B, one cruciform open 271 of the common electrode 270 may be positioned in each basic region of the field generating electrode and these opens 271 may be connected to each other.

Although the illustrated exemplary embodiment describes that the light blocking member 220 is formed on the second display panel 200, the invention is not limited to this configuration. For example, in the case of the liquid crystal display according to another exemplary embodiment of the present invention, the light blocking member 220 may be positioned on the first display panel 100 and in the case of the liquid crystal display according to another exemplary embodiment of the present invention, the color filter 230 may also be positioned on the second display panel 200.

Inner sides of the display panels 100 and 200 are provided with alignment layers (not illustrated) which may be vertical alignment layers.

The polarizer (not illustrated) is disposed on the outer surfaces of the two display panels 100 and 200 and the transmission axes of the two polarizers may be orthogonal to each other, where one of the transmission axes is preferably parallel with the gate line 121. However, a polarizer may also be disposed only on the outer surface of any one of the two display panels 100 and 200.

The liquid crystal layer 3 has a negative dielectric anisotropy and the liquid crystal molecules of the liquid crystal layer 3 are aligned so that the major axes thereof are vertical to the surfaces of the two display panels 100 and 200 in the state in which no electric field is present. Therefore, when no electric field is present, incident light does not pass through the crossed polarizers.

The first subpixel electrode 191a and the second subpixel electrode 191b receive the data voltage to generate an electric field, along with the common electrode 270 of the common electrode display panel 200, such that the liquid crystal molecules of the liquid crystal layer 3 are induced to reorient from a vertical alignment to alignment in a horizontal direction with respect to the surface of the two electrodes 191 and 270. In this manner, the luminance of light passing through the liquid crystal layer 3 may be changed to a desired degree according to the degree by which the liquid crystal molecules are oriented horizontally.

Next, a method for driving a liquid crystal display according to an exemplary embodiment of the present invention will be briefly described.

When a gate on signal is applied to the gate line 121, a gate on signal is applied to the first gate electrode 124a, the second gate electrode 124b, and the third gate electrode 124c and thus a first switching element Qa, a second switching element Qb, and a third switching element Qc are turned on. Therefore, the data voltage applied to the data line 171 is applied to a first subpixel electrode 191a and a second subpixel electrode 191b, respectively, through the first and second switching elements Qa and Qb. However, the voltage applied to the second subpixel electrode 191b is divided through the third switching element Qc which is connected to the second switching element Qb in series. Therefore, the voltage which is applied to the second subpixel electrode 191b is smaller than the voltage applied to the first subpixel electrode 191a.

As such, a magnitude of the second voltage applied to the second subpixel electrode 191b is smaller than that of the first voltage which is applied to the first subpixel electrode 191a. Therefore, a difference in voltage between the first subpixel electrode 191a and the common electrode 270 is larger than a difference in voltage between the second subpixel electrode 191b and the common electrode 270.

Therefore, a charging voltage of a first liquid crystal capacitor which is formed between the first subpixel electrode 191a and the common electrode 270 and a charging voltage of a second liquid crystal capacitor which is formed between the second subpixel electrode 191b and the common electrode 270 represent different gamma curves, and the overall gamma curve of one pixel may be represented by a synthesized gamma curve. Here, the synthesized gamma curve at a front matches a reference gamma curve at a front which is defined to be most appropriate, and a synthesized gamma curve at a side approximates a reference gamma curve at a front. As such, side visibility is improved.

According to the illustrated exemplary embodiment, to make a voltage which is charged in the first liquid crystal capacitor different from a voltage which is charged in the second liquid crystal capacitor, the liquid crystal display includes the third switching element Qc which is connected to an output terminal and a divided reference voltage line of the second switching element Qb. However, according to another exemplary embodiment of the present invention, the third switching element Qc may be connected to the output terminal and a pressure sensitive capacitor of the second switching element Qb. In this case, the third switching element Qc may be connected to gate lines which are different from those of the first switching element Qa and the second switching element Qb. When subsequently driven, the first switching element Qa and the second switching element Qb may be turned on and then turned off, and then the third switching element Qc may be turned on. When the first switching element Qa and the second switching element Qb are turned on and then turned off and then the third switching element Qc is turned on, charges move from the second subpixel electrode 191b to the pressure sensitive capacitor through the third switching element Qc. Then, the charging voltage of the second liquid crystal capacitor is reduced and the pressure sensitive capacitor is charged. The charging voltage of the second liquid crystal capacitor is reduced as according to the capacitance of the pressure sensitive capacitor, and therefore the charging voltage of the second liquid crystal capacitor is reduced relative to that of the first liquid crystal capacitor.

Further, in the case of the liquid crystal display according to another exemplary embodiment of the present invention, the first and second liquid crystal capacitors are each connected to different data lines to be applied with different data voltages, so that the charging voltages of the first and second liquid crystal capacitors are different. In addition, differential charging voltages between the first and second liquid crystal capacitors may be accomplished by any other methods.

Next, a basic region of the field generating electrode of the liquid crystal display according to an exemplary embodiment of the present invention will be described in more detail with reference to FIGS. 3A and 3B. FIG. 3A is a plan view illustrating the basic region of the field generating electrode of the liquid crystal display according to the exemplary embodiment of the present invention. FIG. 3B is an enlarged plan view of a portion of the basic region of the field generating electrode.

As illustrated in FIG. 3A, a basic electrode 199 of the field generating electrode of the liquid crystal display according to the exemplary embodiment of the present invention is configured to include the pixel electrode 191 including the first subpixel electrode 191a and the second subpixel electrode 191b which face the open 271 of the common electrode 270. The second subpixel electrode 191b is formed to enclose or surround the first subpixel electrode 191a.

When viewed in plan view, the open 271 of the common electrode 270 may have a generally cruciform shape, although any suitable shape is contemplated.

The edges of the first subpixel electrode 191a are provided with the plurality of first branch electrodes 192a. The plurality of first branch electrodes 192a extend from the first plate-shaped part 193a which has a rhombus shape. That is, the first subpixel electrode 191a includes the first plate-shaped part 193a which is positioned at the middle portion thereof, and the plurality of first branch electrodes 192a which enclose the first plate-shaped part 193a and extend therefrom.

The central portion of the first plate-shaped part 193a of the first subpixel electrode 191a overlaps the central portion of a cruciform open 271 which is formed in the common electrode 270.

The opens which are formed between the plurality of first branch electrodes 192a of the first subpixel electrode 191a include the extending part 190 where the width of the open is wide at the end PP1 where the first branch electrode 192a meets the first plate-shaped part 193a.

Generally, as the first plate-shaped part 193a is widened, the aperture ratio is increased but the control over the liquid crystal molecules may be weakened. Conversely, as the portion occupied by the first branch electrode 192a is widened, the aperture ratio is reduced but the control over the liquid crystal molecules is increased. Therefore, the appropriate disposition of the first plate-shaped part 193a and the first branch electrode 192a portion may have a significant effect on the degree of control over the liquid crystal molecules.

In particular, referring to FIG. 3B, the liquid crystal molecules which are positioned at the middle portion of the first plate-shaped part 193a are controlled by the liquid crystal molecules which are affected by a fringe field generated at edges of the first plate-shaped part 193a. As a result, the boundary portion of the edge of the first plate-shaped part 193a may be widened to a predetermined distance 2d at each open, such that when viewing the entire first plate-shaped part 193a, the boundary portion of the edge may be widened and more defined.

Therefore, the boundary portion of the edge of the first plate-shaped part 193a may be wider due to the extending part 190, and liquid crystal near the boundary portion of the edge of the first plate-shaped part 193a is greater affected by the fringe field. Thus, the degree of control over the liquid crystal molecules which are positioned at the first plate-shaped part 193a may be improved.

That is, the widened extending part 190 is formed at the end PP1 of the open formed between the first branch electrodes 192a of the first subpixel electrode 191a to make the boundary portions of the edges of the first plate-shaped part 193a larger and more defined, such that the effect of the corresponding fringe field is increased. Accordingly, even the liquid crystal molecules positioned at the middle portion of the first plate-shaped part 193a are affected by the liquid crystal molecules at the boundary portions, thereby improving control over all the liquid crystal molecules positioned corresponding to the first plate-shaped part 193a, thus improving the response speed of the pixel.

The first branch electrodes 192a of the first subpixel electrode 191a extend in different directions. In more detail, the first branch electrode 192a includes the plurality of first fine branch parts 194a which obliquely extend upward left from the first plate-shaped part 193a, the plurality of second fine branch parts 194b which obliquely extend upward right therefrom, the plurality of third fine branch parts 194c which obliquely extend downward left therefrom, and the plurality of fourth fine branch parts 194d which obliquely extend downward right therefrom.

The second subpixel electrode 191b includes the second plate-shaped part 193b which encloses the plurality of first branch electrodes 192a of the first subpixel electrode 191a, and the plurality of second branch electrodes 192b which enclose the second plate-shaped part 193b and extend from the second plate-shaped part 193b.

The opens which are formed between the plurality of second branch electrodes 192b of the second subpixel electrode 191b include the extending part 190 where the width of the open is widened at its base.

As described above, generally, as the second plate-shaped part 193b is widened, the aperture ratio is increased but the degree of control over the liquid crystal molecules may be weakened. Conversely, as the area occupied by the second branch electrode 192b is widened, the aperture ratio is reduced but the degree of control over the liquid crystal molecules is improved. Therefore, the appropriate proportions of the second plate-shaped part 193b and the second branch electrode 192b portion may have an important effect on the aperture ratio and the control power of the liquid crystal molecules.

In plan view, the second plate-shaped part 193b of the second subpixel electrode 191b generally has a shape made up of four trapezoidal structures which are positioned at outsides of the first to fourth fine branch parts 194a, 194b, 194c, and 194d of the first subpixel electrode 191a. Similar to the first branch electrode 192a of the first subpixel electrode 191a, the second branch electrodes 192b of the second subpixel electrode 191b include the plurality of fifth fine branch parts 194e which obliquely extend upward left from the second plate-shaped part 193b, the plurality of sixth fine branch parts 194f which obliquely extend upward right therefrom, the plurality of seventh fine branch parts 194g which obliquely extend downward left therefrom, and the plurality of eighth fine branch parts 194h which obliquely extend downward right therefrom.

The first to fourth fine branch parts 194a, 194b, 194c, and 194d and the fifth to eighth fine branch parts 194e, 194f, 194g, and 194h are oriented approximately ±45° or ±135° with respect to a first direction D1 in which the gate line 121 extends.

Further, the two fine branch parts 194a, 194b, 194c, 194d, 194e, 194f, 194g, and 194h which extend in different directions and are adjacent to each other may be orthogonal to each other.

In the liquid crystal display according to the exemplary embodiment of the present invention, one pixel area may further include two to four of the basic electrodes 199 illustrated in FIGS. 3A and 3B. However, embodiments of the invention are not limited thereto, and any number and arrangement of these basic electrodes 199 are contemplated.

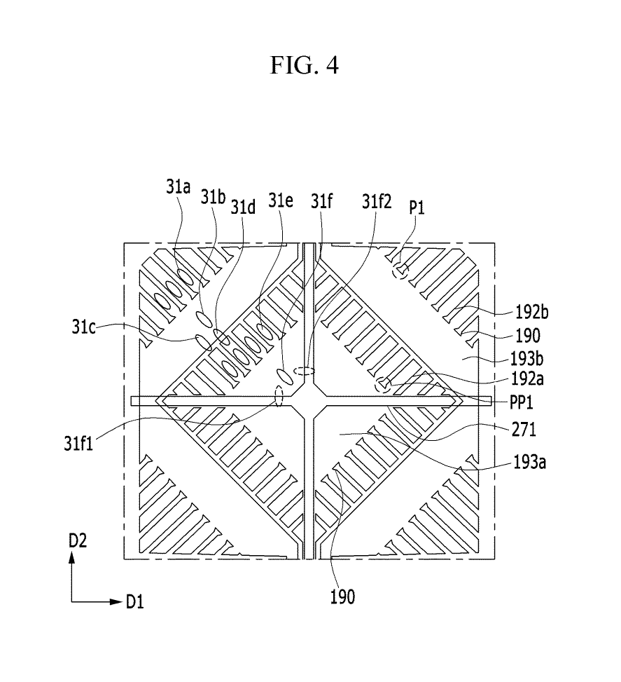

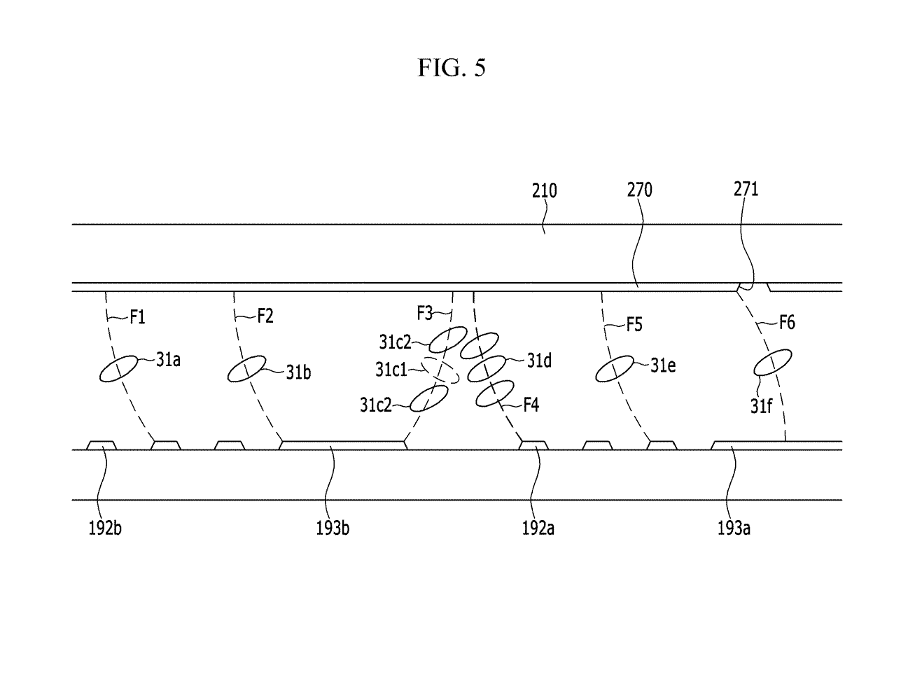

Next, the alignment of the liquid crystal molecules in the basic region of the field generating electrode of the liquid crystal display according to an exemplary embodiment of the present invention will be described with reference to FIGS. 4 and 5.

FIG. 4 is a conceptual diagram illustrating an alignment direction of directors of liquid crystal molecules of the liquid crystal display according to the exemplary embodiment of the present invention, and FIG. 5 is a cross-sectional view illustrating the alignment direction of the directors of the liquid crystal molecules of the liquid crystal display according to the exemplary embodiment of the present invention.

Referring to FIGS. 4 and 5, a first fringe field F1 is generated in a direction which is largely vertical with respect to the edge of the second branch electrodes 192b, and first liquid crystal molecules 31a which are positioned around the second branch electrodes 192b are inclined perpendicular to the direction of the first fringe field F1 and then collide with each other and thus are inclined parallel to a length direction in which the second branch electrodes 192b extend.

Second liquid crystal molecules 31b which are positioned at a first edge of the second plate-shaped part 193b are affected by a second fringe field F2 generated at the first edge of the second plate-shaped part 193b, and thus are inclined in the same direction in which the first liquid crystal molecules 31a are inclined.

In this case, unlike the second branch electrodes 192b, the fringe field which may control the liquid crystal molecules is slightly weaker at the second plate-shaped part 193b and thus the amount of control over the liquid crystal may be reduced and the response speed of the liquid crystal molecules may be slightly reduced.

The opens which are formed between the second branch electrodes 192b include the extending part 190 where the width of the open is wider at an end P1.

As described above, generally, as the second plate-shaped part 193b is widened, the aperture ratio is increased but the control over the liquid crystal molecules may be weakened, and as a portion occupied by the second branch electrode 192b is widened, the aperture ratio is reduced but the control over the liquid crystal molecules is improved. Therefore, the appropriate sizing of the second plate-shaped part 193b and the second branch electrode 192b portion may have an important effect on the aperture ratio and the degree of control over the liquid crystal molecules.

A third fringe field F3 is generated at a second edge opposite to the edge at which second fringe field F2 is generated. Accordingly, absent the fourth fringe field F4 which is discussed below, third fringe field F3 would orient a first part 31c1 of the liquid crystal molecules perpendicular to field F3, and generally opposite to the direction in which liquid crystal molecules 31a and 31b are oriented.

Further, a fourth fringe field F4 is generated at a third edge of the first branch electrode 192a, and fourth liquid crystal molecules 31d adjacent to the third edge of the first branch electrode 192a are inclined in a direction vertical to a fourth fringe field F4. The direction is substantially the same as the direction in which the first liquid crystal molecules 31a and the second liquid crystal molecules 31b are inclined.

As described above, the magnitude of voltage applied to the first subpixel electrode 191a is larger than the magnitude of voltage applied to the second subpixel electrode 191b. Therefore, a difference in voltage between the first subpixel electrode 191a and the common electrode 270 is larger than a difference in voltage between the second subpixel electrode 191b and the common electrode 270, and thus a magnitude of the fourth fringe field F4 is larger than a magnitude of the third fringe field F3. Therefore, a second part 31c2 of the third liquid crystal molecules 31c which would otherwise be oriented by third fringe field F3 is affected by the fourth fringe field F4 to be inclined in a direction perpendicular to the fourth fringe field F4. Therefore, the first part 31c1 of the third liquid crystal molecules 31c is instead oriented parallel with the second part 31c2 of the third liquid crystal molecules 31c which are affected by the fourth fringe field F4. By this, the third liquid crystal molecules 31c which are positioned between the first subpixel electrode 191a and the second subpixel electrode 191b are inclined parallel to their nearby second liquid crystal molecules 31b and the fourth liquid crystal molecules 31d, such that luminance of the liquid crystal display may be increased. When the direction in which the liquid crystal molecules positioned at the boundary portion between the first subpixel electrode 191a and the second subpixel electrode 191b are inclined is different from the direction in which the liquid crystal molecules positioned to correspond to the first subpixel electrode 191a and the second subpixel electrode 191b are inclined, the boundary portion between the first subpixel electrode 191a and the second subpixel electrode 191b is darker than the boundary between first subpixel electrode 191a and the second subpixel electrode 191b, such that the entire luminance of the liquid crystal display may be reduced.

Fifth liquid crystal molecules 31e corresponding to the first branch electrode 192a of the first subpixel electrode 191a are affected by a fifth fringe field F5 generated at the edge of the first branch electrode 192a and thus are inclined perpendicular to the direction of the fifth fringe field F5 and then collide with each other, such that the fifth liquid crystal molecules 31e are inclined in a direction parallel to a length direction in which the first branch electrode 192a extends.

In this case, unlike the portion at which the plurality of first branch electrodes 192a are formed, the fringe field which may control the liquid crystal molecules is slightly weak at the first plate-shaped part 193a and thus the control over the liquid crystal may be reduced, such that the response speed of the liquid crystal molecules may be slightly reduced.

Further, a third part 31f1 and a fourth part 31f2 among sixth liquid crystal molecules 31f corresponding to the first plate-shaped part 193a of the first subpixel electrode 191a are primarily inclined perpendicular to the edges of the open 271 by a sixth fringe field F6 which is applied to the cruciform open 271. The third part 31f1 and the fourth part 31f2 also meet each other and thus are secondarily aligned in a direction in which a deformation thereof is minimized, so that the secondary alignment direction becomes a vector sum of directions toward which the third part 31f1 and the fourth part 31f2 head. Therefore, liquid crystal molecules are inclined in a direction parallel with a length direction in which the first branch electrodes 192a extend.

As such, according to the exemplary embodiment of the present invention, the first subpixel electrode 191a to which a relatively higher voltage is applied is formed at a central portion to overlap the central portion of the cruciform open 271 of the common electrode 270, and the plurality of first branch electrodes 192a are formed at the edge of the first subpixel electrode 191a. Further, the second subpixel electrode 191b to which a relatively lower voltage is applied is positioned to surround the first subpixel electrode 191a, and the plurality of second branch electrodes 192b are formed at the edge of the second subpixel electrode 191b.

As described above, the first branch electrode 192a and the second branch electrode 192b of the first subpixel electrode 191a and the second subpixel electrode 191b have the plurality of fine branch parts 194a, 194b, 194c, 194d, 194e, 194f, 194g, and 194h which extend in different directions, such that the liquid crystal molecules are inclined in different directions. Therefore, a viewing angle of the liquid crystal display is widened.

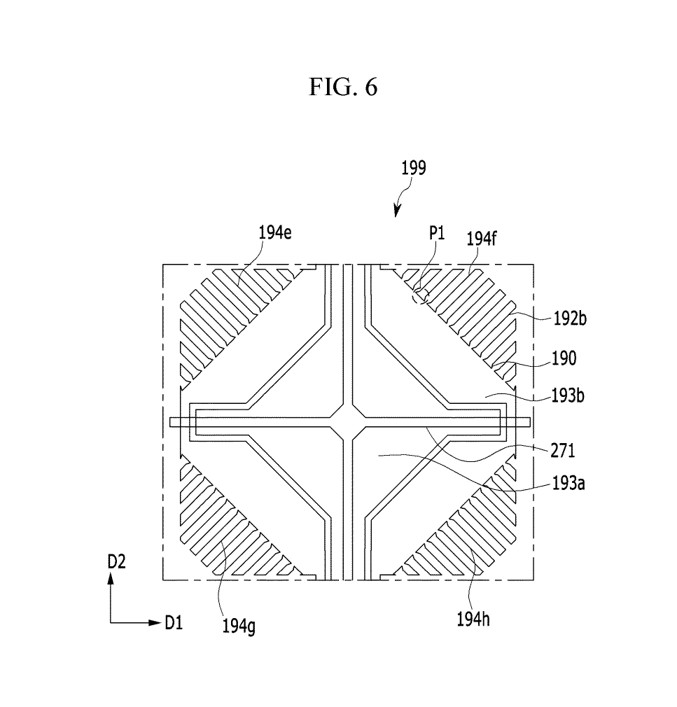

Hereinafter, a basic region of a field generating electrode of a liquid crystal display according to another exemplary embodiment of the present invention will be described with reference to FIG. 6.

FIG. 6 is a plan view illustrating a basic region of a field generating electrode of a liquid crystal display according to another exemplary embodiment of the present invention. As illustrated in FIG. 6, the basic electrode 199 of the field generating electrode of the liquid crystal display according to another exemplary embodiment of the present invention is configured to include the pixel electrode 191, including the first subpixel electrode 191a and the second subpixel electrode 191b which face the open 271 of the common electrode 270. The second subpixel electrode 191b is formed to enclose the first subpixel electrode 191a.

When viewed from the top, the open 271 of the common electrode 270 may have a generally cruciform or cross shape.

The first subpixel electrode 191a does not have a branch electrode and is formed of the first plate-shaped part 193a. The first plate-shaped part 193a of the first subpixel electrode 191a generally has a rhombus shape in plan view.

The central portion of the first plate-shaped part 193a of the first subpixel electrode 191a overlaps the central portion of the cruciform open 271 which is formed in the common electrode 270.

The second subpixel electrode 191b includes the second plate-shaped part 193b which surrounds or encloses the first subpixel electrode 191a, and the plurality of second branch electrodes 192b which enclose the second plate-shaped part 193b and extend from the second plate-shaped part 193b.

The opens which are formed between the plurality of second branch electrodes 192b include the extending part 190 where the width of the open is wider at an end P1 of an open than at other parts of the open.

In plan view, the second plate-shaped part 193b of the second subpixel electrode 191b is generally shaped as four trapezoidal structures positioned at the outside of the first subpixel electrode 191a. The plurality of second branch electrodes 192b of the second subpixel electrode 191b include the plurality of fifth fine branch parts 194e which obliquely extend upward left from the second plate-shaped part 193b, the plurality of sixth fine branch parts 194f which obliquely extend upward right therefrom, the plurality of seventh fine branch parts 194g which obliquely extend downward left therefrom, and the plurality of eighth fine branch parts 194h which obliquely extend downward right therefrom.

The fifth to eighth fine branch parts 194e, 194f, 194g, and 194h may be oriented approximately ±45° or ±135° with respect to the first direction D1 in which the gate line 121 extends. Further, the two fine branch parts 194e, 194f, 194g, and 194h which extend in different directions and are adjacent to each other may be orthogonal to each other.

Unlike the liquid crystal display according to the exemplary embodiment illustrated in FIGS. 3A and 3B, in the liquid crystal display according to the present exemplary embodiment, the first subpixel electrode 191a does not have fine branch parts extending from its edges. Therefore, the liquid crystal molecules which are positioned at the boundary portion between the first subpixel electrode 191a and the second subpixel electrode 191b are more affected by the fringe field of the first subpixel electrode 191a.

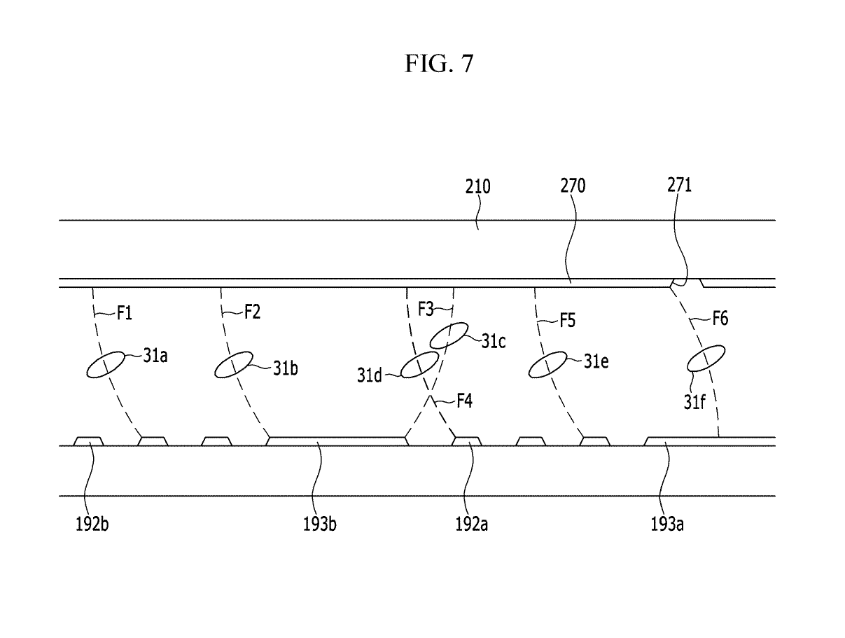

This will be described in more detail with reference to FIG. 7.

FIG. 7 is a cross-sectional view illustrating the alignment direction of the directors of the liquid crystal molecules of the liquid crystal display according to another exemplary embodiment of the present invention.

Referring to FIG. 7, the first fringe field F1 is generated substantially vertical or perpendicular to the edge of the second branch electrode 192b of the second subpixel electrode 191b, and therefore the first liquid crystal molecules 31a which are positioned around the second branch electrode 192b are inclined perpendicular to the direction of the first fringe field F1 and then collide with each other and thus are inclined in the parallel to a length direction in which the second branch electrodes 192b extend.

The second liquid crystal molecules 31b which are positioned at the first edge of the second plate-shaped part 193b of the second subpixel electrode 191b are affected by the second fringe field F2 generated at the first edge of the second plate-shaped part 193b, and thus are inclined in the same direction as that in which the first liquid crystal molecules 31a are inclined.

However, unlike the portion at which the plurality of second branch electrodes 192b are formed, the fringe field which may control the liquid crystal molecules is slightly weaker at the second plate-shaped part 193b, and thus the control over the liquid crystal may be reduced and the response speed of the liquid crystal molecules may be slightly reduced.

Therefore, the opens which are formed between the plurality of second branch electrodes 192b of the second subpixel electrode 191b according to the exemplary embodiment of the present invention include the extending part 190 where the width of the open is wider proximate to the second plate shaped part 193b

The third fringe field F3 is generated at the second edge of the second plate-shaped part 193b and third liquid crystal molecules 31c are affected by the third fringe field F3 and thus may be inclined in a direction opposite to the direction in which the first liquid crystal molecules 31a and the second liquid crystal molecules 31b are inclined.

Further, the third part 31f1 and the fourth part 31f2 are primarily inclined in the direction perpendicular to the edge of the open 271 by the sixth fringe field F6 which is applied to the cruciform open 271. Where the third part 31f1 and the fourth part 31f2 meet each other, their alignment direction becomes the vector sum of the orientations of the third part 31f1 and the fourth part 31f2. Therefore, liquid crystal molecules are inclined in a direction parallel with a length direction in which the second branch electrodes 192b extend.

The magnitude of voltage applied to the first subpixel electrode 191a is larger than the magnitude of voltage applied to the second subpixel electrode 191b. Therefore, the difference in voltage between the first subpixel electrode 191a and the common electrode 270 is larger than the difference in voltage between the second subpixel electrode 191b and the common electrode 270. Therefore, a magnitude of the sixth fringe field F6 is larger than the magnitude of the third fringe field F3. In addition, since the first subpixel electrode 191a has a straight edge adjacent to the second subpixel electrode 191b, the effect of the sixth fringe field F6 is increased.

Therefore, the third liquid crystal molecules 31c which are positioned between the first subpixel electrode 191a and the second subpixel electrode 191b are more greatly affected by the sixth fringe field F6 than the third fringe field F3 and thus are inclined in a direction parallel with the length direction in which the second branch electrodes 192b extend. Therefore, the third liquid crystal molecules 31c which would otherwise be inclined in a direction perpendicular to the third fringe field F3 due to the effect of the third fringe field F3 are instead oriented parallel with the fourth part 31f which is affected by the sixth fringe field F6.

By this, the liquid crystal molecules which are positioned at the boundary between the first subpixel electrode 191a and the second subpixel electrode 191b are inclined in parallel with the liquid crystal molecules corresponding to the first subpixel electrode 191a and the liquid crystal molecules corresponding to the second subpixel electrode 191b, thereby increasing the luminance of the liquid crystal display.

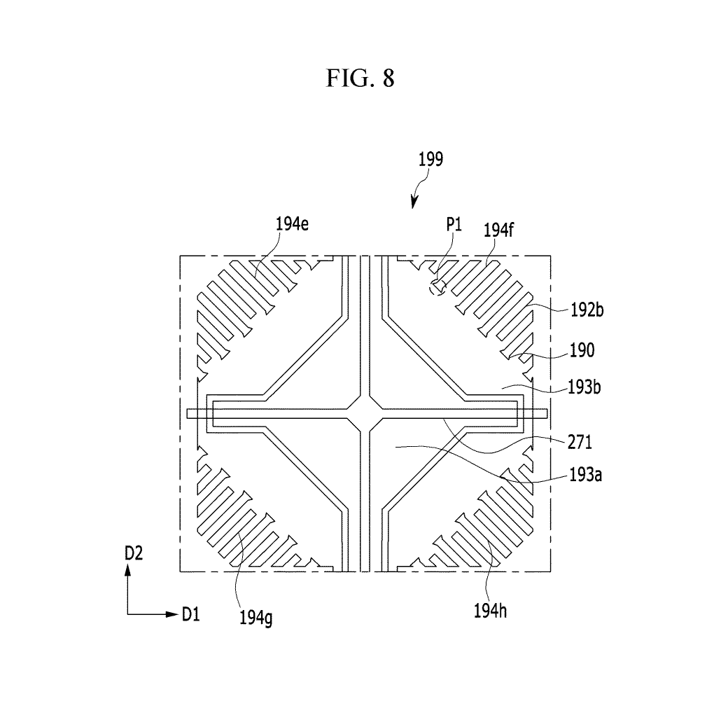

Hereinafter, the basic region of the field generating electrode of the liquid crystal display according to another exemplary embodiment of the present invention will be described with reference to FIG. 8.

FIG. 8 is a plan view illustrating the basic region of the field generating electrode of the liquid crystal display according to another exemplary embodiment of the present invention.

Compared to the liquid crystal display according to the embodiment illustrated in FIG. 6, the liquid crystal display according to the exemplary embodiment illustrated in FIG. 8 is substantially the same except for the form of the second branch electrodes 192b, and thus any repeated description thereof will be omitted.

As illustrated in FIG. 8, the second subpixel electrode 191b includes the second plate-shaped part 193b which encloses the first subpixel electrode 191a and the plurality of second branch electrodes 192b which enclose the second plate-shaped part 193b and extend from the second plate-shaped part 193b.

Here, odd-numbered opens and even-numbered opens which are formed between the plurality of second branch electrodes 192b are formed to have different lengths. Alternating opens, or gaps, have the same length, as measured from the edge of the second plate-shaped part 193b to the tip of the corresponding second branch electrode 192b.

Generally, as a plate-shaped electrode region is widened, the transmittance or the aperture ratio is improved but the degree of control over the liquid crystal molecules may be reduced, and to the contrary, as the region in which the branch electrode is formed is widened, the response speed of the liquid crystal molecules may be increased and the degree of control over the liquid crystal molecules may be improved but the transmittance or the aperture ratio may be reduced.

Therefore, the transmittance and the control power of the liquid crystal molecules may be improved by making half of the opens which are formed between the plurality of second branch electrodes 192b long and the remaining half short.

However, unlike the portion at which the plurality of second branch electrodes 192b are formed, the fringe field which may control the liquid crystal molecules is slightly weak at the second plate-shaped part 193b and thus the degree of control over the liquid crystal may be reduced and the response speed of the liquid crystal molecules may be slightly reduced.

Therefore, the opens which are formed between the plurality of second branch electrodes 192b of the second subpixel electrode 191b according to the exemplary embodiment of the present invention include the extending part 190 where the width of the open is wider at an end P1 of the open proximate to the second plate-shaped part 193b. As above, this widens and defines the edge of the second plate-shaped part 193b, increasing the effect of the fringe field generated at edges of the second plate-shaped part 193b and thus increasing the degree of control over the liquid crystal in that region.

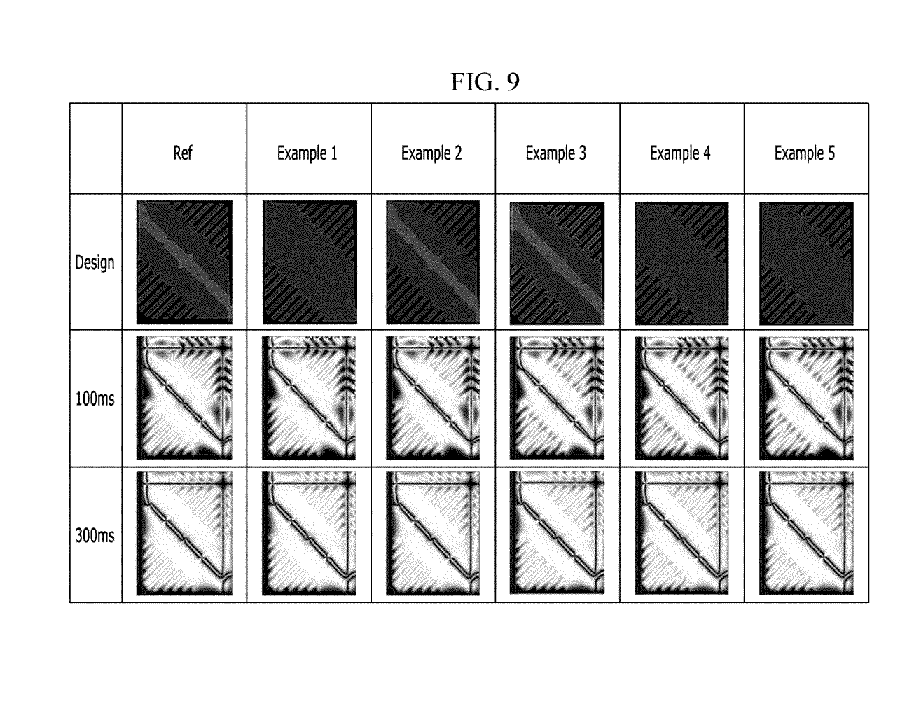

Next, an experimental example of the present invention will be described with reference to FIG. 9. FIG. 9 is a diagram illustrating a measurement result of transmittance of the liquid crystal display according to the exemplary embodiment of the present invention.

In the present experimental example, an experiment was performed using the liquid crystal display according to the exemplary embodiment of FIG. 8 and a change in the transmittance was measured while changing the size of the extending part of the end of the open and the difference in the lengths of the even-numbered and odd-numbered opens, respectively.

As illustrated in FIG. 9, even when the extending part is formed at the end of the open between the branch electrodes, it may be appreciated that the transmittance only slightly deteriorates.

Therefore, it may be appreciated that the extending part is formed at the end of the open between the branch electrodes to implement sufficient transmittance while improving the response speed and the control power of the liquid crystal molecule.

As described above, it is possible to increase the response speed of the liquid crystal without reducing the aperture ratio of the liquid crystal display while making the side visibility approximate the front visibility. This can be done by forming extensions in the pixel electrodes, where the widths of the ends of the opens between the plurality of branch electrodes are widened.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Various features of different embodiments and structures described herein can be mixed and matched in any manner, to form further embodiments and structures contemplated by the invention.

### DESCRIPTION OF SYMBOLS

100: First display panel 200: Second display panel

| | |
|---|---|
| 110: First substrate | 210: Second substrate |
| 3: Liquid crystal layer | 121: Gate line |
| 131: Reference voltage line | 135: Storage electrode |
| 124: Gate electrode | 140: Gate insulating layer |
| 154: Semiconductor | 163, 165: Ohmic contact |
| 173: Source electrode | 175: Drain electrode |
| 180: Passivation layer | 230: Color filter |
| 80: Capping layer | 191: Pixel electrode |

| | |
|---|---|
| 191a, 191b: First, second subpixel electrode | 199: Basic electrode |

192a, 192b: first, second branch electrode 193a, 193b: First, second plate-shaped part

| | |
|---|---|
| 190: Extending part | 270: Common electrode |
| 271: Open | 194: Fine branch part |
| 185: Contact hole | 195: Connecting member |
| 136: Extending part | 220: Light blocking member |
| F: Fringe field | 31: Liquid crystal molecule |

What is claimed is:

1. A liquid crystal display, comprising:
a first substrate;
a pixel electrode formed on the first substrate and including a first subpixel electrode and a second subpixel electrode which are separated from each other;
a second substrate facing the first substrate;
a common electrode formed on the second substrate; and
a liquid crystal layer positioned between the first substrate and the second substrate,
wherein the first subpixel electrode includes a first part having a plurality of first branch electrodes,
the second subpixel electrode includes a second part which is positioned to at least partially surround the first branch electrodes, and which further includes a plurality of second branch electrodes which extend from the second part and are defined by a plurality of first opens, and
portions of the first opens proximate to the second part are wider than other portions of the first opens.

2. The liquid crystal display of claim 1, wherein:
a difference between a first voltage configured to be applied to the first subpixel electrode and a common voltage configured to be applied to the common electrode is larger than a difference between a second voltage configured to be applied to the second subpixel electrode and the common voltage.

3. The liquid crystal display of claim 2, wherein:
the first part of the first subpixel electrode has a substantially quadrilateral shape, and
the second part of the second subpixel electrode has a plurality of substantially trapezoidal shapes.

4. The liquid crystal display of claim 1, wherein:
the plurality of first branch electrodes extend from the first part and are separated from each other by a plurality of second opens, and
portions of the second opens proximate to the first part are wider than other portions of the second opens.

5. The liquid crystal display of claim 4, wherein:
a difference between a first voltage configured to be applied to the first subpixel electrode and a common voltage configured to be applied to the common electrode is larger than a difference between a second voltage configured to be applied to the second subpixel electrode and the common voltage.

6. The liquid crystal display of claim 5, wherein:
the first part of the first subpixel electrode has a substantially quadrilateral shape,
the second part of the second subpixel electrode has a plurality of substantially trapezoidal shapes,
the plurality of first branch electrodes includes a first fine branch part, a second fine branch part, a third fine branch part, and a fourth fine branch part which extend in different directions, and
the plurality of second branch electrodes includes a fifth fine branch part, a sixth fine branch part, a seventh fine branch part, and an eighth fine branch part which extend in different directions.

7. The liquid crystal display of claim 1, wherein:
adjacent ones of the first opens have differing lengths, and
longer ones of the first opens have ends that are wider than ends of shorter ones of the first opens.

8. The liquid crystal display of claim 7, wherein:
a difference between a first voltage configured to be applied to the first subpixel electrode and a common voltage configured to be applied to the common electrode is larger than a difference between a second voltage configured to be applied to the second subpixel electrode and the common voltage.

9. The liquid crystal display of claim 8, wherein:
the first part of the first subpixel electrode has a substantially quadrilateral shape,
the second part of the second subpixel electrode has a plurality of substantially trapezoidal shapes.

10. The liquid crystal display of claim 4, wherein:
adjacent ones of the second opens have differing lengths, and
longer ones of the second opens have ends that are wider than ends of shorter ones of the second opens.

11. The liquid crystal display of claim 10, wherein:
a difference between a first voltage configured to be applied to the first subpixel electrode and a common voltage configured to be applied to the common electrode is larger than a difference between a second voltage configured to be applied to the second subpixel electrode and the common voltage.

12. The liquid crystal display of claim 11, wherein:
the first part of the first subpixel electrode has a substantially quadrilateral shape,
the second part of the second subpixel electrode has a plurality of substantially trapezoidal shapes,
the plurality of first branch electrodes includes a first fine branch part, a second fine branch part, a third fine branch part, and a fourth fine branch part which extend in different directions, and
the plurality of second branch electrodes includes a fifth fine branch part, a sixth fine branch part, a seventh fine branch part, and an eighth fine branch part which extend in different directions.
